(19) United States
(12) Patent Application Publication
(10) Pub. No.: US 2022/0304470 A1
(43) Pub. Date: Sep. 29, 2022

(54) FUNCTIONAL CHAIR

(71) Applicant: Baleun GNB Co., Ltd., Gyeongsangbuk-do (KR)

(72) Inventors: Jong Yeong HA, Daegu (KR); Ki Ju KO, Daejeon (KR)

(73) Assignee: Baleun GNB Co., Ltd., Gyeongsangbuk-do (KR)

(21) Appl. No.: 17/289,252

(22) PCT Filed: Feb. 4, 2021
(86) PCT No.: PCT/KR2021/001456

§ 371 Date: Apr. 28, 2021

(30) Foreign Application Priority Data
Feb. 6, 2020 (JP) 10-2020-0014365

(51) Int. Cl. A47C 3/16; A47C 7/02

(52) U.S. Cl. CPC A47C 3/16; A47C 7/029

(57) ABSTRACT

A functional chair is disclosed. The functional chair includes a first plate that accommodates a hip and a thigh when a user is seated on the functional chair, a second plate that accommodates a waist and a back when the user is seated on the functional chair, and a connecting portion that connects the first plate and the second plate. The second plate may have an acupressure portion that adheres to the waist when the user is seated on the functional chair.

### TECHNICAL FIELD

The following description relates to a functional chair, and more particularly, to a functional chair equipped with an acupressure portion.

### BACKGROUND ART

A basic function of a chair is to support an upper body of a user when resting and working. The chair generally includes an assembly that supports a hip and lumbar vertebrae, and includes a spring, a cushion, a pad disposed on the spring, or the like. When using the chair, the user generally takes two characteristic postures, including a posture of leaning backward to take a rest or a posture leaning forward to perform a task. The chair may be deformed to be suitable for such two characteristic postures to support the body of the user. Various chairs have been introduced that make the user's upper body comfortable and help maintain good posture during rest. The chair may be equipped with a back support, but since most of such back supports have a non-adjustable structure, the user becomes easily tired when sitting on the chair for a long time, causing pressed nerve of the lumbar vertebrae and spinal deformation. Therefore, there is a need for research on a functional chair to resolve these issues.

### DISCLOSURE OF INVENTION

### Technical Solution

According to an aspect, there is provided a functional chair including a first plate that accommodates a hip and a thigh of a user when the user is seated on the functional chair, a second plate that accommodates a waist and a back of the user when the user is seated on the functional chair, and a connecting portion that connects the first plate and the second plate. The second plate may include an acupres sure portion formed to adhere to the waist when the user is seated on the sitting chair.

A lower end of the acupres sure portion may be connected to the connecting portion, an upper end and side ends of the acupres sure portion may be spaced from the second plate, and the acupres sure portion may be formed in one area at a central location of the second plate to provide a function of pressing and supporting the waist.

When the user is seated on the sitting chair and the back of the user leans against the second plate, the second plate and the acupressure portion may be deformed with an elastic force, but with different restoring forces.

The acupressure portion may include a plurality of protrusions configured to be deformed according to the waist of the user with an elastic force to further strengthen an acupressure effect on the waist, when the user is seated on the sitting chair.

The first plate may have a shape in which a front part is lifted upward, and the second plate and the connecting portion may include a flexible material.

When the user is seated on the sitting chair and leans backward, a front part of the first plate may be lowered by a weight of the user, and the acupressure portion may provide an acupressure effect on the waist with a restoring force greater than a restoring force of a different part of the second plate.

A supporting portion may be formed in one surface of the first plate by which the functional chair is in contact with the floor to prevent the functional chair from falling backward when the user is seated on the functional chair.

### EFFECTS

According to an example embodiment, it is possible to effectively support a back of a user and maximize an acupressure effect on lumbar vertebrae of the user when the user is seated on the functional chair.

### BRIEF DESCRIPTION OF DRAWINGS

FIG. 1 is a perspective view of a functional chair according to an example embodiment.

FIG. 2 is a front view of the functional chair according to an example embodiment.

FIG. 3 is a rear view of the functional chair according to an example embodiment.

FIG. 4 is a side view of the functional chair according to an example embodiment.

FIG. 5 is a top view of the functional chair according to an example embodiment.

FIG. 6 is a bottom view of the functional chair according to an example embodiment.

FIG. 7 illustrates an example of a functional chair when the user is seated thereon according to an example embodiment.

### BEST MODE FOR CARRYING OUT THE INVENTION

Hereinafter, example embodiments will be described in detail with reference to the accompanying drawings. It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments.

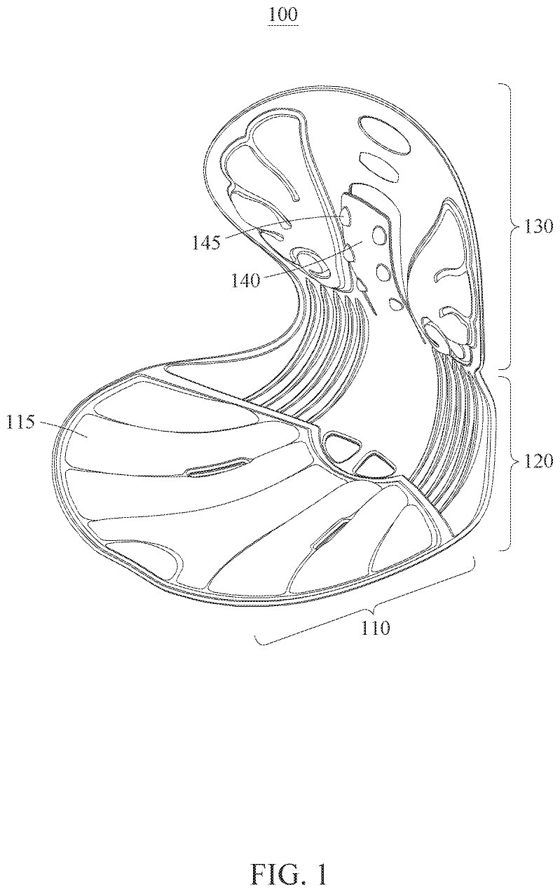

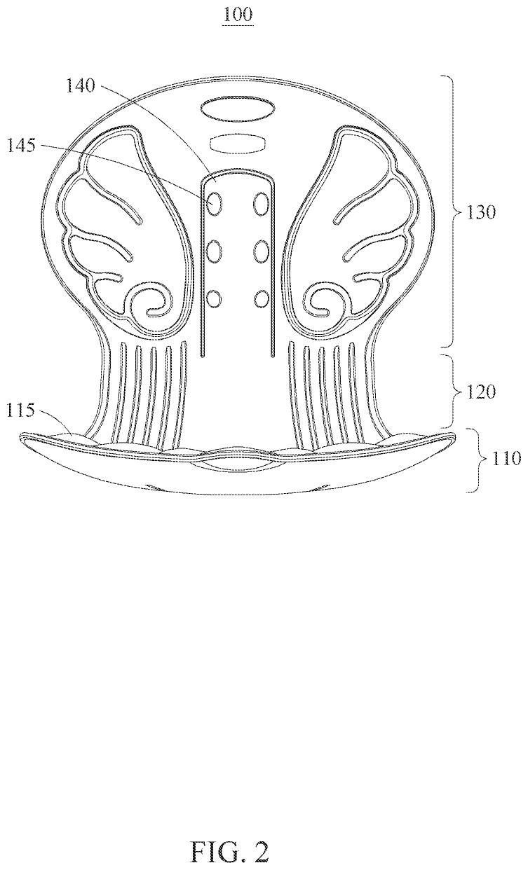

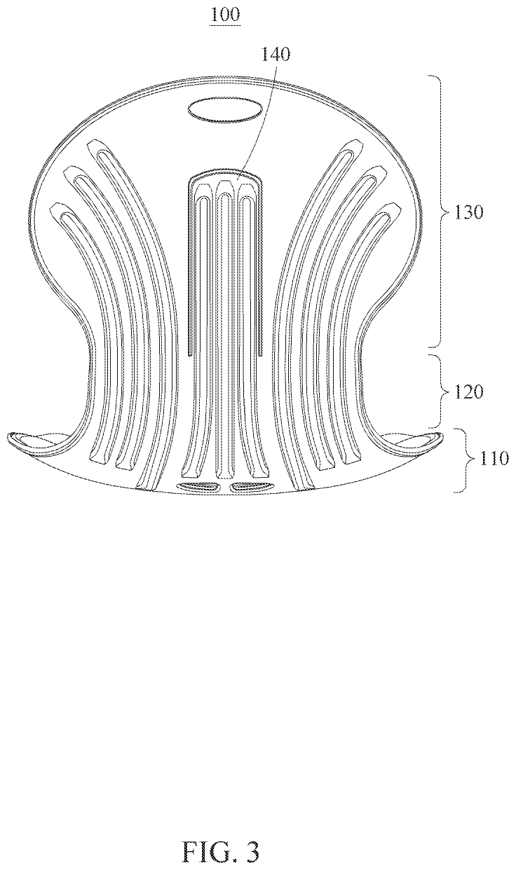

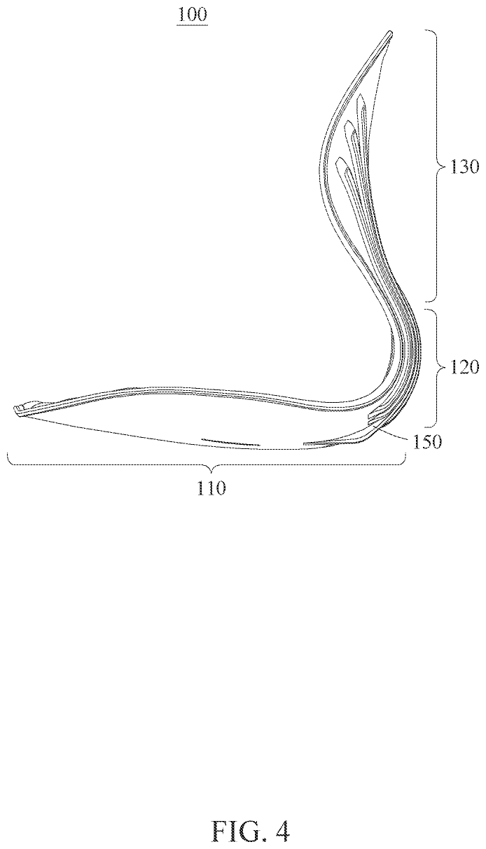

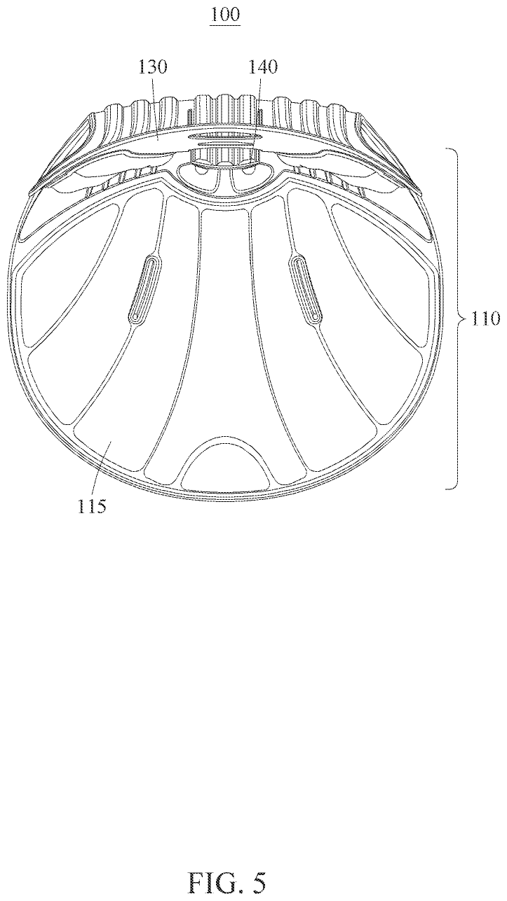

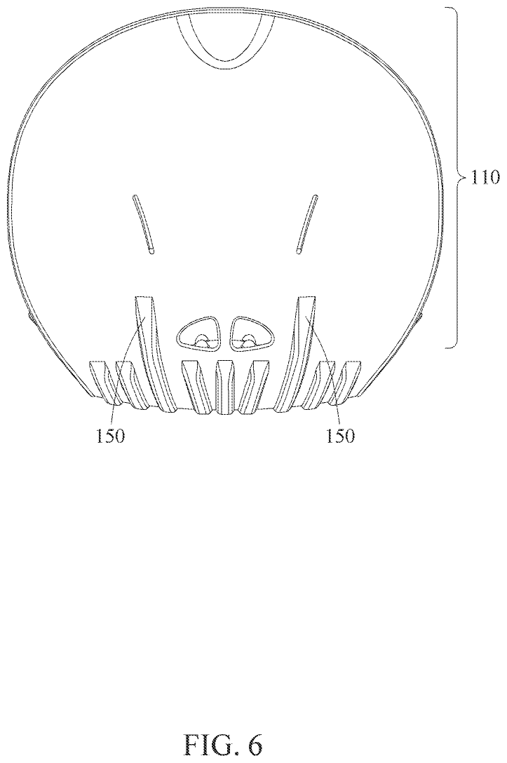

FIG. 1 is a perspective view of a functional chair φaccording to an example embodiment. FIG. 2 is a front view of the functional chair 100 according to an example embodiment. FIG. 3 is a rear view of the functional chair 100 according to an example embodiment. FIG. 4 is a side view of the functional chair 100 according to an example embodiment. FIG. 5 is a top view of the functional chair 100 according to an example embodiment. FIG. 6 is a bottom view of the functional chair 100 according to an example embodiment.

Referring to the accompanying drawings, the functional chair 100, or more particularly, the functional chair 100 equipped with an acupres sure portion 140 is illustrated. The functional chair 100 includes a first plate 110, a second plate 130, and a connecting portion 120 that connects the first plat 110 and the second plate 130. The first plate 110 accommodates a hip and a thigh of a user when the user is seated on the functional chair 100, and the second plate 130 accommodates a waist and a back of the user when the user is seated on the functional chair 100. The first plate 110, the second plate 130, and the connecting portion 120 may be integrally formed. The first plate 110, the second plate 130, and the connecting portion 120 may be formed with one same material or a plurality of different materials. The functional chair 100 may also be referred to herein as a sitting chair.

The first plate 110 may be a sitting plate on which the thigh and the hip of the user are seated, and have a shape in which a front part is slightly lifted upward. The first plate 110 may be equipped with a detachable plate-shaped sitting cushion 115. For example, the first plate 110 and the sitting cushion 115 may be detachable with a Velcro portion. The user may replace the sitting cushion 115 depending on predetermined needs. For example, the user may replace the sitting cushion 115 of the first plate 110 to wash the sitting cushion 115 or use another sitting cushion. Therefore, the user may wash the sitting cushion 115 of the functional chair 100, and use a sitting cushion made of cooling materials in summer or heating materials in winter.

The second plate 130 may be a back plate extending from a rear part of the connecting portion 120 and supports the waist and back of the user. The second plate 130 may have a curve to adhere to the waist and back, and be connected to the first plate 110 with the connecting portion 120. For example, the second plate 130 may curve forward in a longitudinal direction.

As illustrated, the connecting portion 120 may be formed as a curve, where the user's hip is located when the user is seated on the functional chair 100. The connecting portion 120 and the second plate 130 may include a flexible material that provides an elastic force. According to an example embodiment, in addition to the connecting portion 120 and the second plate 130, the first plate 110 may also include a flexible material.

The second plate 130 may be formed with the acupressure portion 140 that adheres to the waist when the user is seated on the functional chair 100. For example, the acupres sure portion 140 may be formed in one area at a central location of the second plate 130 to provide a function of pressing and supporting the waist. The acupressure portion 140 and the second plate 130 may be integrally formed.

According to an example embodiment, a lower end of the acupres sure portion 140 may be connected to the connecting portion 120, and an upper end and side ends of the acupressure portion 140 may be spaced from the second plate 130. Also, the acupressure portion 140 may protrude from a surface of the second plate 130. Due to such structural characteristics, the second plate 130 and the acupressure portion 140 may be deformed with an elastic force, albeit have different restoring forces, when the user is seated on the functional chair 100 and leans back on the second plate 130. Since the acupressure portion 140 protrudes forward than the second plate 130, an increased force is applied onto the waist adhering to the acupressure portion 140 than other body parts adhering to the second plate 130 when the user leans back on the second plate 130. The acupres sure portion 140 may maximize an acupres sure effect on the lumbar vertebrae of the user as it provides a strong pressure and force. According to an example embodiment, when the user is seated on the functional chair 100 and leans backward, the front part of the first plate 110 may be lowered by the user's weight, and the acupres sure portion 140 may provide the acupressure effect on the user's waist with a restoring force greater than a restoring force of a different part of the second plate 130.

According to another example embodiment, the acupressure portion 140 and the second plate 130 may have different degrees of elasticity. For example, due to a difference in material included in the acupressure portion 140 and the second plate 130, the acupres sure portion 140 may have a greater restoring force than the second plate 130.

Also, the acupres sure portion 140 may have a shape corresponding to a shape of the user's waist, which is curved according to the user's body shape.

The acupressure portion 140 includes a plurality of protrusions 145 to stimulate the user's waist when the user is seated on the functional chair 100. These protrusions 145 may be formed with various materials. For example, the protrusions 145 may include a hard and rigid material or a material that provides a soft tension. The protrusions 145 may be arranged at a predetermined interval in a longitudinal direction of the second plate 130, and in bilateral symmetry. The protrusions 145 may further strengthen the acupressure effect of the functional chair 100 on the waist.

The functional chair 100 described above may effectively provide the acupres sure effect on the waist with the acupres sure portion 140 that is integrally formed with the first plate 110 and the second plate 130, even without a complex structure or a hinge. By integrally forming the acupressure portion 140 and other structural components, a manufacturing process of the functional chair 100 may be simplified, and a manufacturing cost for the functional chair 100 reduced. Also, the functional chair 100 equipped with the acupres sure portion 140 may provide an effect of preventing deformation, fatigue, and pain of the lumbar vertebrae when the user is seated on the chair. The user may comfortably sit on the functional chair 100 for a long period of time, feeling comfort and no pain in the lumbar vertebrae, and maintain a correct posture.

A supporting portion 150 may be formed in one surface (floor surface or bottom surface) of the first plate 110 by which the functional chair 100 is in contact with the floor to prevent the functional chair 100 from falling backward when the user is seated on the functional chair 100. According to an example embodiment, the supporting portion 150 may be formed on both left and right sides. When the user sits on the functional chair 100 and adheres the waist to the acupressure portion 140, the supporting portion 150 formed in the first plate 110 may support a seating surface of the functional chair 100 so that the functional chair 100 does not fall further back. The user's waist and the acupres sure portion 140 of the functional chair 100 may become more adherent to each other by the supporting portion 150, and the acupressure portion 140 and the protrusions 145 formed in the acupressure portion 140 maximize the acupressure effect on the user's waist.

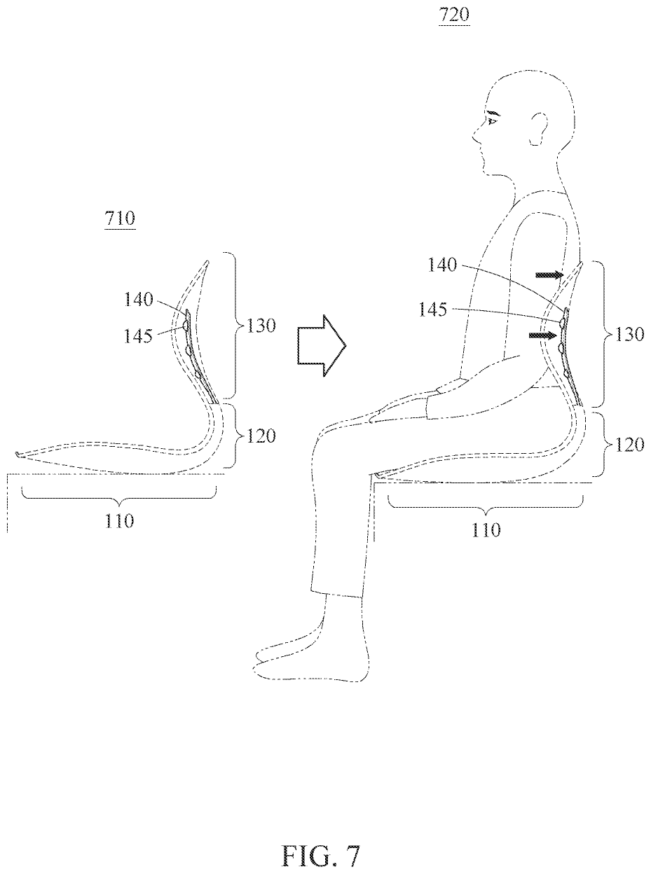

FIG. 7 illustrates an example of the functional chair 100 when a user is seated according to an example embodiment.

Referring to FIG. 7, a left portion 710 illustrates a case where the user is not seated on the functional chair 100, and a right portion 720 a case where the user is seated on the functional chair 100.

As illustrated in the left portion 710, before the user is seated on the functional chair 100, the acupressure portion 140 including the protrusions 145 may protrude forward than other surfaces of the second plate 130.

As illustrated in the right portion 720, when the user is seated on the functional chair 100 and leans backward, the connecting portion 120 and the second plate 130 may be deformed with an elastic force. When the user sits on the functional chair 100, the front part of the first plate 100 may be lowered by the weight of the user, and the connecting portion 120 and the second plate 130 integrally formed with the first plate 110 adhere to the waist and back of the user while providing an elastic force thereto. The second plate 130 may have a shape curved forward in a longitudinal direction, allowing the second plate 130 to have a form that supports the waist that is bent and the back that leans backward when the user is seated on the functional chair 100, to support and adhere the user's waist and back by closely adhering thereto.

When the user is seated on the functional chair 100 and leans backward, the acupressure portion 140 may be deformed with an elastic force according to the user's waist. According to an example embodiment, the acupres sure portion 140 may provide an acupressure effect on the user's waist with a restoring force greater than a restoring force of different parts of the second plate 130. The functional chair 100 in which the first plate 110, the second plate 130, the connecting portion 120, and the acupressure portion 140 are integrally formed may provide the user with the acupressure effect based on an elastic force of the acupressure portion 140, and enable the user to sit in a correct posture. In addition, when the user is seated on the functional chair 100, an effect of separating the second plate 130 into left and right sides based on the acupressure portion 140 may occur. The second plate 130 may thus effectively support the back of the user.

Although the example embodiments have been described with reference to the limited drawings as described above, various modifications and changes may be made from the foregoing descriptions by those skilled in the art. For example, suitable results can be achieved even if the described techniques are performed in a different order, and/or even if components of the described structure, device, and the like are coupled or combined in a different manner, or are replaced or substituted by other components or their equivalents.

Therefore, the scope of the example embodiments is defined not by the detailed description, but by the claims and their equivalents, and all variations within the scope of the claims and their equivalents are to be construed as being included in the example embodiments.

### DESCRIPTION OF REFERENCE NUMERALS

| | |
|---|---|
| 100: Functional chair | 110: First plate |
| 115: Sitting cushion | 120: Connecting portion |
| 130: Second plate | 140: Acupressure portion |
| 145: Protrusions | 150: Supporting portion |

1. A sitting chair comprising:
a first plate that accommodates a hip and a thigh of a user when the user is seated on the sitting chair;
a second plate that accommodates a waist and a back of the user when the user is seated on the sitting chair; and
a connecting portion that connects the first plate and the second plate,
wherein the second plate comprises:
an acupressure portion formed to adhere to the waist when the user is seated on the sitting chair.

2. The sitting chair of claim 1, wherein a lower end of the acupressure portion is connected to the connecting portion,
an upper end and side ends of the acupres sure portion are spaced from the second plate, and
the acupressure portion is formed in one area at a central location of the second plate to provide a function of pressing and supporting the waist.

3. The sitting chair of claim 1, wherein, when the user is seated on the sitting chair and the back of the user leans against the second plate, the second plate and the acupres sure portion are deformed with an elastic force, but with different restoring forces.

4. The sitting chair of claim 1, wherein the acupressure portion comprises:
a plurality of protrusions configured to be deformed according to the waist of the user with an elastic force to further strengthen an acupressure effect on the waist, when the user is seated on the sitting chair.

5. The sitting chair of claim 1, wherein the first plate has a shape in which a front part is lifted upward, and
the second plate and the connecting portion comprise a flexible material.

6. The sitting chair of claim 1, wherein, when the user is seated on the sitting chair and leans backward, a front part of the first plate is lowered by a weight of the user, and the acupressure portion provides an acupressure effect on the waist with a restoring force greater than a restoring force of a different part of the second plate.

7. The sitting chair of claim 1, wherein the acupressure portion has a different degree of elasticity from that of the second plate, and a shape corresponding to a shape of the waist of the user.

8. The sitting chair of claim 1, wherein a supporting portion is formed in one surface of the first plate by which the sitting chair is in contact with the floor to prevent the sitting chair from falling backward when the user is seated on the sitting chair.
